(19) United States
(12) Patent Application Publication
(10) Pub. No.: US 2018/0325110 A1
(43) Pub. Date: Nov. 15, 2018

(54) MICRO-CARBON PLANT ANTHOCYANIN FOR FACILITATING ADVANCEMENT OF FRUIT COLORING AND FRUIT PLUMPNESS, AND PREPARATION METHOD AND APPLICATION THEREOF

(71) Applicant: Mingqiang Zhang, Shanxi (CN)

(72) Inventor: Mingqiang Zhang, Shanxi (CN)

(21) Appl. No.: 15/774,433

(22) PCT Filed: Jun. 17, 2016
(86) PCT No.: PCT/CN2016/086120

§ 371 Date: May 8, 2018

(51) Int. Cl. A01N 43/16; A01G 22/05; A01G 7/06; A01N 25/12; A01N 63/02

(52) U.S. Cl. CPC A01N 43/16; A01G 22/05; A01G 7/06; A01N 37/44; A01N 63/02; A01N 2300/00; A01N 25/12

(57) ABSTRACT

A micro-carbon plant anthocyanin for facilitating advancement of fruit coloring and fruit plumpness, and a preparation method and application thereof are provided. The formula composition of the micro-carbon plant anthocyanin by mass percentage is 30-50% of plant anthocyanin having a particle size of 80-150 μm, 20-40% of micro carbon (abbreviation for water-soluble small-molecule carbohydrates) having a particle size of 100 μm and 20-50% of amino acids. By spraying a 100-500-fold dilution of the micro-carbon plant anthocyanin onto surfaces of foliage and fruits during the fruit development period of grapes and strawberries with a use amount of 10-50 kg/mu in the whole growth period, the colorization can be advanced by 5-15 days, and the harvested fruits have fragrant and sweet tastes, are completely filled, and have an excellent quality.

### CROSS-REFERENCE TO RELATED APPLICATION

This application is a national phase entry of, and claims priority to, International Application No. PCT/CN2016/086120, filed Jun. 17, 2016, with the same title as listed above. The above-mentioned patent application is incorporated herein by reference in its entirety.

### TECHNICAL FIELD

The present invention relates to improvements in fruit crop cultivation, and more particularly to an anthocyanin for facilitating advancement of fruit coloring and fruit plumpness.

### BACKGROUND

Anthocyanin is a water-soluble pigment that can change color with the pH of cytochylema. When the cytochylema is acidic, it is reddish in color, and when the cytochylema is basic, it is bluish in color. Anthocyanin is one of the main pigments that make up the color of a petal and a fruit. Anthocyanin is a secondary metabolism product of a plant and plays an important physiological role. The color of a petal and a fruit can attract an animal for pollination and seed dispersal. Anthocyanin is commonly found in a tissue of a flower or a fruit, and in an epidermal cell and a layer of lower epidermis of a stem or a leaf. The market price of some fruit is determined by a color depth, thereby making the concentration of anthocyanin an important factor when selling such fruit.

The coloration time of a fruit such as grapes, strawberries, and apples depends on the concentration of the anthocyanin synthesized in them. More anthocyanin allows conversion of more red pigment and earlier coloring. Also, consumers have increasingly high demands for fruit quality, and increasing the content of anthocyanin in a plant plays a key role in improving the coloring time of a fruit.

Thus, it would be desirable to provide a product and method for improving the coloring and plumpness of fruit.

### SUMMARY

To solve the above problem, the present invention provides a micro-carbon plant anthocyanin for increasing the content of anthocyanin in a fruit, advancing the colorization period of a fruit, increasing the content of soluble solids in fruit cells, and making the pulp cells compact and completely filled, and a preparation method and application thereof.

To achieve the above object, the present invention according to one embodiment provides a micro-carbon plant anthocyanin for facilitating advancement of fruit coloring and fruit plumpness. The formula composition of the micro-carbon plant anthocyanin by mass percentage is as follows: 30-50% of plant anthocyanin, 20-40% of micro carbon (abbreviation for water-soluble small-molecule carbohydrates), and 20-50% of amino acids.

In one aspect, the particle size of the plant anthocyanin is preferably 80-150 μm.

In another aspect, the particle size of the micro carbon is preferably 100 μm.

In some embodiments, the amino acids preferably include methionine, leucine and threonine.

In a further aspect, the fruit preferably includes grapes, strawberries, apples, and sweet cherries.

The present invention according to another embodiment provides a method for preparing a micro-carbon plant anthocyanin for facilitating advancement of fruit coloring and fruit plumpness. The method includes the steps of: (1) raw materials: plant stems and leaves rich in anthocyanin, a humic acid, and amino acids, which should all meet standards for grains; (2) biodegradation of the raw materials: active yeast species are added into the humic acid, sealed and fermented, and degraded into small-molecule carbohydrates, and the active yeast species are added into the plant stems and leaves rich in anthocyanin, sealed and fermented, degraded and activated, and purified to obtain the plant anthocyanin; (3) canning of semi-finished product: the micro carbon and the plant anthocyanin are extracted according to quality standards, and then separately stored in cans; (4) dispensing and mixing: the above micro carbon, plant anthocyanin and amino acids are thoroughly mixed in proportion; and (5) inspection, and achievement of finished product.

The present invention in a further embodiment provides an application of the micro-carbon plant anthocyanin for facilitating advancement of fruit coloring and fruit plumpness. To this end, the application includes spraying a 100-500-fold dilution of the micro-carbon plant anthocyanin onto surfaces of foliage and fruits during the fruit development period, with a use amount of 10-50 kg/mu in the whole growth period.

The present invention achieves several technical effects and advantages. In the present invention, by using biotechnologies, the plant stems and leaves rich in anthocyanin are activated and purified to obtain a plant anthocyanin having a particle size of 80-150 μm in average. As derived from a plant, the plant anthocyanin has natural affinity with plants, and is readily absorbed and converted into a red pigment when sprayed on surfaces of foliage and fruits such that the coloration period of the fruits is advanced. The micro carbon contained in the micro-carbon plant anthocyanin of the present invention is obtained by performing biodegradation in the humic acid and then purifying, so the micro carbon can quickly enter fruit cells to increase the content of soluble solids in fruit cells and make the pulp cells compact and completely filled. Upon experiments, by spraying a 100-500-fold dilution of the micro-carbon plant anthocyanin onto surfaces of foliage and fruits during the fruit development period of grapes, strawberries, apples, and sweet cherries, with a use amount of 10-50 kg/mu in the whole growth period, the colorization can be advanced by 5-15 days, and the harvested fruits have fragrant and sweet tastes, are completely filled, and have an excellent quality.

### DETAILED DESCRIPTION

Various additional features and advantages of the invention will become more apparent to those of ordinary skill in the art upon review of the following detailed description of one or more illustrative embodiments. To this end, although no drawings are included with this application, the above and other technical features and advantages of the present invention will be described in more detail in connection with the following embodiments.

### Embodiment 1

The micro-carbon plant anthocyanin according to this embodiment defines a formula composition of 30% of plant anthocyanin having a particle size of 80 μm, 30% of micro carbon of 100 μm, and 40% of methionine.

The method of preparing the micro-carbon plant anthocyanin of this embodiment includes the following steps:

(1) raw materials: plant stems and leaves rich in anthocyanin, a humic acid, and amino acids, which should all meet standards for grains;

(2) biodegradation of the raw materials: active yeast species are added into the humic acid, sealed and fermented, and degraded into micro carbons, and the active yeast species are added into the plant stems and leaves rich in anthocyanin, sealed and fermented, degraded and activated, and purified to obtain the plant anthocyanin;

(3) canning of semi-finished product: the micro carbon of 100 μm and the plant anthocyanin having a particle size of 80 μm are extracted according to quality standards, and then separately stored in cans;

(4) dispensing and mixing: the above micro carbon, plant anthocyanin and amino acids are thoroughly mixed in proportion; and

(5) inspection, and achievement of finished product.

### Embodiment 2

The micro-carbon plant anthocyanin according to this embodiment defines a formula composition of 40% of plant anthocyanin having a particle size of 80 μm, 40% of micro carbon of 100 μm, and 20% of leucine.

The method of preparing the micro-carbon plant anthocyanin of this embodiment includes the following steps:

(1) raw materials: plant stems and leaves rich in anthocyanin, a humic acid, and amino acids, which should all meet standards for grains;

(2) biodegradation of the raw materials: active yeast species are added into the humic acid, sealed and fermented, and degraded into micro carbons, and the active yeast species are added into the plant stems and leaves rich in anthocyanin, sealed and fermented, degraded and activated, and purified to obtain the plant anthocyanin;

(3) canning of semi-finished product: the micro carbon of 100 μm and the plant anthocyanin having a particle size of 80 μm are extracted according to quality standards, and then separately stored in cans;

(4) dispensing and mixing: the above micro carbon, plant anthocyanin and amino acids are thoroughly mixed in proportion; and

(5) inspection, and achievement of finished product.

### Embodiment 3

The micro-carbon plant anthocyanin according to this embodiment defines a formula composition of 50% of plant anthocyanin having a particle size of 80 μm, 20% of micro carbon of 100 μm, and 30% of threonine.

The method of preparing the micro-carbon plant anthocyanin of this embodiment includes the following steps:

(1) raw materials: plant stems and leaves rich in anthocyanin, a humic acid, and amino acids, which should all meet standards for grains;

(2) biodegradation of the raw materials: active yeast species are added into the humic acid, sealed and fermented, and degraded into micro carbons, and the active yeast species are added into the plant stems and leaves rich in anthocyanin, sealed and fermented, degraded and activated, and purified to obtain the plant anthocyanin;

(3) canning of semi-finished product: the micro carbon of 100 μm and the plant anthocyanin having a particle size of 80 μm are extracted according to quality standards, and then separately stored in cans;

(4) dispensing and mixing: the above micro carbon, plant anthocyanin and amino acids are thoroughly mixed in proportion; and

(5) inspection, and achievement of finished product.

At a strawberry planting base, a comparison is made between application and no application of the micro-carbon plant anthocyanin prepared in Embodiment 1, and when a 200-fold dilution of the micro-carbon plant anthocyanin is sprayed onto the surfaces of foliage for 5 times with a use amount of 10 kg/mu, the harvested fruits have fragrant and sweet tastes, are completely filled, and have an excellent quality.

At a grape planting base, a comparison is made between application and no application of the micro-carbon plant anthocyanin prepared in Embodiment 2, and when a 100-fold dilution of the micro-carbon plant anthocyanin is sprayed onto the surfaces of foliage for 5 times with a use amount of 30 kg/mu, the harvested fruits have fragrant and sweet tastes, are completely filled, and have an excellent quality.

At an apple planting base, a comparison is made between application and no application of the micro-carbon plant anthocyanin prepared in Embodiment 3, and when a 300-fold dilution of the micro-carbon plant anthocyanin is sprayed onto the surfaces of foliage for 5 times with a use amount of 20 kg/mu, the harvested fruits have fragrant and sweet tastes, are completely filled, and have an excellent quality. Thus, for each of the embodiments described herein, the application of the micro-carbon plant anthocyanin achieves the improvements and technical effects described above.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

1. A micro-carbon plant anthocyanin for facilitating advancement of fruit coloring and fruit plumpness of a fruit, wherein a formula composition of the micro-carbon plant anthocyanin by mass percentage is:
30-50% of plant anthocyanin,
20-40% of micro carbon, and
20-50% of amino acids.

2. The micro-carbon plant anthocyanin of claim 1, wherein a particle size of the plant anthocyanin is 80-150 μm.

3. The micro-carbon plant anthocyanin of claim 1, wherein a particle size of the micro carbon is 100 μm.

4. The micro-carbon plant anthocyanin of claim 1, wherein the amino acids comprise at least one of methionine, leucine and threonine.

5. The micro-carbon plant anthocyanin of claim 1, wherein the fruit comprises grapes, strawberries, apples, and sweet cherries and wherein the micro-carbon plant anthocyanin is configured to improve coloring and plumpness of the fruit when applied in a growing process for the fruit.

6. A method for preparing a micro-carbon plant anthocyanin for facilitating advancement of fruit coloring and fruit plumpness, comprising the steps of:
(1) preparing raw materials, including plant stems and leaves rich in anthocyanin, a humic acid, and amino acids;
(2) conducting biodegradation of the raw materials by adding active yeast species into the humic acid, and then sealing and fermenting the yeast species and the humic acid, resulting in degradation into micro carbons, and by adding the active yeast species into the plant stems and leaves rich in anthocyanin, and then sealing and fermenting the yeast species and the plant stems and leaves, resulting in degradation, activation, and purification to obtain a plant anthocyanin;
(3) extracting the micro carbons and the plant anthocyanin, and canning the micro carbons and the plant anthocyanin to be stored in cans;
(4) mixing the micro carbons, the plant anthocyanin and the amino acids in proportion to form a mixture; and
(5) inspecting and storing finished product defined by the mixture.

7. An application of a micro-carbon plant anthocyanin for facilitating advancement of fruit coloring and fruit plumpness, comprising:
providing the micro-carbon plant anthocyanin with a formula composition by mass percentage of 30-50% of plant anthocyanin, 20-40% of micro carbon, and 20-50% of amino acids; and
spraying a 100-500-fold dilution of the micro-carbon plant anthocyanin onto surfaces of foliage and fruits during a base period of fruit development, with a use amount of 10-50 kg/mu in an entire growth period for the foliage and fruits.

8. The application of the micro-carbon plant anthocyanin of claim 7, wherein the micro-carbon plant anthocyanin includes a formula composition by mass percentage of 30% of the plant anthocyanin, 30% of the micro carbon, and 40% of methionine, and wherein the step of spraying further comprises:
spraying a 100-500-fold dilution of the micro-carbon plant anthocyanin onto strawberries.

9. The application of the micro-carbon plant anthocyanin of claim 7, wherein the micro-carbon plant anthocyanin includes a formula composition by mass percentage of 40% of the plant anthocyanin, 40% of the micro carbon, and 20% of leucine, and wherein the step of spraying further comprises:
spraying a 100-500-fold dilution of the micro-carbon plant anthocyanin onto grapes.

10. The application of the micro-carbon plant anthocyanin of claim 7, wherein the micro-carbon plant anthocyanin includes a formula composition by mass percentage of 50% of the plant anthocyanin, 20% of the micro carbon, and 30% of threonine, and wherein the step of spraying further comprises:
spraying a 100-500-fold dilution of the micro-carbon plant anthocyanin onto apples.

11. The method of claim 6, wherein the mixture formed in step (4) includes a formula composition by mass percentage of:
30-50% of the plant anthocyanin,
20-40% of the micro carbons, and
20-50% of the amino acids.

12. The method of claim 11, wherein the amino acids include methionine, and the mixture formed in step (4) includes a formula composition by mass percentage of:
30% of the plant anthocyanin,
30% of the micro carbons, and
40% of the methionine.

13. The method of claim 11, wherein the amino acids include leucine, and the mixture formed in step (4) includes a formula composition by mass percentage of:
40% of the plant anthocyanin,
40% of the micro carbons, and
20% of the leucine.

14. The method of claim 11, wherein the amino acids include threonine, and the mixture formed in step (4) includes a formula composition by mass percentage of:
50% of the plant anthocyanin,
20% of the micro carbons, and
30% of the threonine.

15. The micro-carbon plant anthocyanin of claim 1, wherein the amino acids include methionine, and the micro-carbon plant anthocyanin includes a formula composition by mass percentage of:
30% of the plant anthocyanin,
30% of the micro carbons, and
40% of the methionine.

16. The micro-carbon plant anthocyanin of claim 1, wherein the amino acids include leucine, and the micro-carbon plant anthocyanin includes a formula composition by mass percentage of:
40% of the plant anthocyanin,
40% of the micro carbons, and
20% of the leucine.

17. The micro-carbon plant anthocyanin of claim 1, wherein the amino acids include threonine, and the micro-carbon plant anthocyanin includes a formula composition by mass percentage of:
50% of the plant anthocyanin,
20% of the micro carbons, and
30% of the threonine.
